(19) United States
(12) Patent Application Publication
(10) Pub. No.: US 2016/0148247 A1
(43) Pub. Date: May 26, 2016

(54) PERSONALIZED ADVERTISEMENT SELECTION SYSTEM AND METHOD

(71) Applicant: Intel Corporation, Santa Clara, CA (US)

(72) Inventors: JIANGUO LI, Beijing (CN); TAO WANG, Beijing (CN); YANGZHOU DU, Beijing (CN); QIANG LI, BEIJING (CN); YIMIN ZHANG, BEIJING (CN)

(73) Assignee: INTEL CORPORATION, Santa Clara, CA (US)

(21) Appl. No.: 14/921,725

(22) Filed: Oct. 23, 2015

Related U.S. Application Data
(63) Continuation of application No. 13/991,323, filed on Jan. 28, 2014, now abandoned.

(51) Int. Cl. G06Q 30/02; G06K 9/00

(52) U.S. Cl. CPC G06Q 30/0242; G06Q 30/0267; G06Q 30/0269; G06K 9/00228; G06K 9/00281; G06K 9/00288; G06K 9/00302

(57) ABSTRACT

A system and method for selecting an advertisement to present to a consumer includes detecting facial regions in the image, identifying one or more consumer characteristics (mood, gender, age, etc.) of said consumer in the image, identifying one or more advertisements to present to the consumer based on a comparison of the consumer characteristics with an advertisement database including a plurality of advertisement profiles, and presenting a selected one of the identified advertisement to the consumer on a media device.

### CROSS-REFERENCE TO RELATED APPLICATIONS

This application is a Continuation of U.S. application Ser. No. 13/991,323 filed Jan. 28, 2014, which is a U.S. national stage completion of International Application No. PCT/CN2011/000621 filed Apr. 11, 2011, the entire contents of which are herein incorporated by reference.

### FIELD

The present disclosure relates to the field of data processing, and more particularly, to methods, apparatuses, and systems for selecting one or more advertisements based on face detection/tracking, facial expressions (e,g., mood), gender, age, and/or face identification/recognition.

### BACKGROUND

Advertisements may be targeted to market goods and services to different demographic groups. Unfortunately, media providers (such as, but not limited to, television providers, radio providers, and/or advertisement providers) traditionally have passively presented advertisements to the consumers. Because the consumer viewing and/or listening to the advertisement may be part of a demographic group different than the advertisement's targeted demographic group(s), the effectiveness of the advertisements may be diminished.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 illustrates one embodiment of a system for selecting and displaying advertisements to a consumer based on facial analysis of the consumer consistent with various embodiments of the present disclosure;

FIG. 2 illustrates one embodiment of a face detection module consistent with various embodiments of the present disclosure;

FIG. 3 illustrates one embodiment of an advertisement selection module consistent with various embodiments of the present disclosure;

FIG. 4 is a flow diagram illustrating one embodiment for selecting and displaying an advertisement consistent with the present disclosure; and

FIG. 5 is a flow diagram illustrating another embodiment for selecting and displaying an advertisement consistent with the present disclosure.

### DETAILED DESCRIPTION

By way of an overview, the present disclosure is generally directed to a system, apparatus, and method for selecting one or more advertisements to present a consumer, based on a comparison of consumer characteristics identified from an image, with an advertisement database of advertising profiles. The consumer characteristics may be identified from the image using facial analysis. The system may generally include a camera for capturing one or more images of a consumer, a face detection module configured to analyze the image to determine one or more characteristics of the consumer, and an advertisement selection module configured to select an advertisement to provide to the consumer based on a comparison of consumer characteristics identified from an image with an advertisement database of advertising profiles. As used herein, the term “advertisement” is intended to mean television advertisements, billboard advertisements, radio advertisements (including AM/FM radio, satellite radio, as well as subscription based radio), in-store advertising, digital sign advertising, etc.), and digital menu boards.

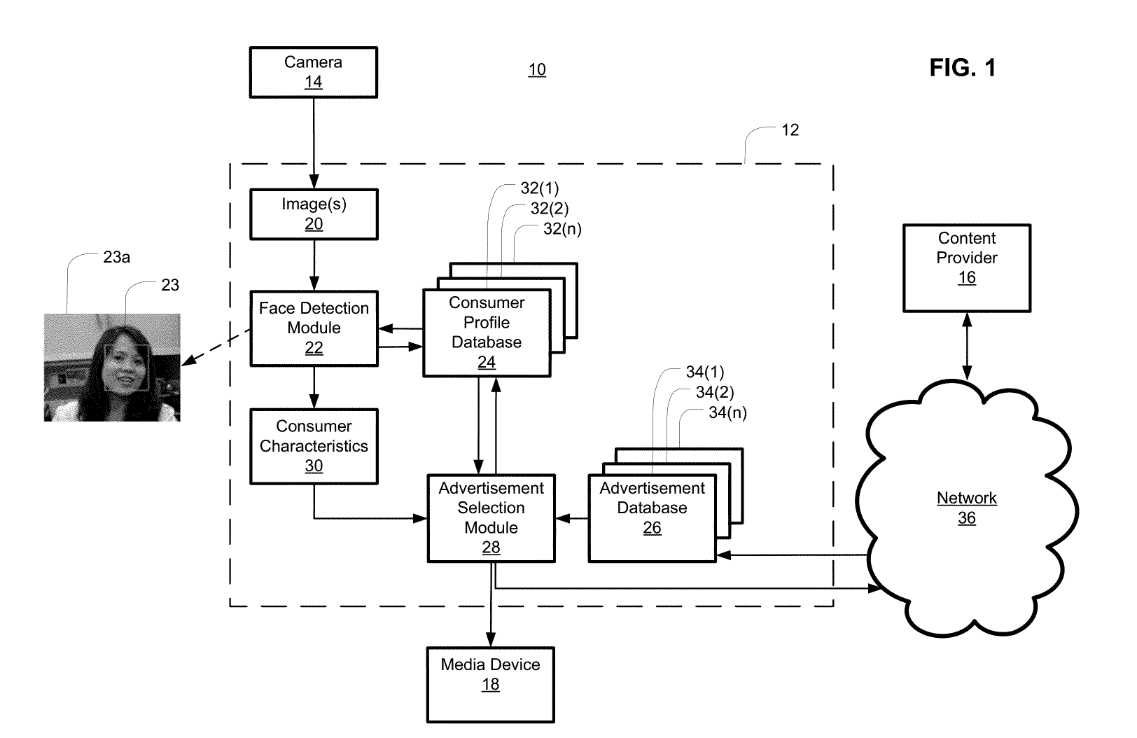

Turning now to FIG. 1, one embodiment of a system 10 consistent with the present disclosure is generally illustrated. The system 10 includes an advertisement selection system 12, camera 14, a content provider 16, and a media device 18. As discussed in greater detail herein, the advertisement selection system 12 is configured identify at least one consumer characteristic from one or more images 20 captured by the camera 14 and to select an advertisement from the media provider 16 for presentation to the consumer on the media device 18.

In particular, the advertisement selection system 12 includes a face detection module 22, a consumer profile database 24, an advertisement database 26, and an advertisement selection module 28. The face detection module 22 is configured to receive one or more digital images 20 captured by at least one camera 14. The camera 20 includes any device (known or later discovered) for capturing digital images 20 representative of an environment that includes one or more persons, and may have adequate resolution for face analysis of the one or more persons in the environment as described herein. For example, the camera 20 may include a still camera (i.e., a camera configured to capture still photographs) or a video camera (i.e., a camera configured to capture a plurality of moving images in a plurality of frames). The camera 20 may be configured to capture images in the visible spectrum or with other portions of the electromagnetic spectrum (e.g., but not limited to, the infrared spectrum, ultraviolet spectrum, etc.). The camera 20 may include, for example, a web camera (as may be associated with a personal computer and/or TV monitor), handheld device camera (e.g., cell phone camera, smart phone camera (e.g., camera associated with the iPhone®, Trio®, Blackberry®, etc.), laptop computer camera, tablet computer (e.g., but not limited to, iPad®, Galaxy Tab®, and the like), etc.

The face detection module 22 is configured to identify a face and/or face region (e.g., as represented by the rectangular box 23 in the inset 23a referenced by the dotted line) within the image(s) 20 and, optionally, determine one or more characteristics of the consumer (i.e., consumer characteristics 30). While the face detection module 22 may use a marker-based approach (i.e., one or more markers applied to a consumer's face), the face detection module 22, in one embodiment, utilizes a markerless-based approach. For example, the face detection module 22 may include custom, proprietary, known and/or after-developed face recognition code (or instruction sets), hardware, and/or firmware that are generally well-defined and operable to receive a standard format image (e.g., but not limited to, a RGB color image) and identify, at least to a certain extent, a face in the image.

In addition, the face detection module 22 may also include custom, proprietary, known and/or after-developed facial characteristics code (or instruction sets) that are generally well-defined and operable to receive a standard format image (e.g., but not limited to, a RGB color image) and identify, at least to a certain extent, one or more facial characteristics in the image. Such known facial characteristics systems include, but are not limited to, standard Viola-Jones boosting cascade framework, which may be found in the public Open Source Computer Vision (OpenCV™) package. As discussed in greater detail herein, consumer characteristics 30 may include, but are not limited to, consumer identity (e.g., an identifier associated with a consumer) and/or facial characteristics (e.g., but not limited to, consumer age, consumer age classification (e.g., child or adult), consumer gender, consumer race,), and/or consumer expression identification (e.g., happy, sad, smiling, frown, surprised, excited, etc.)).

The face detection module 22 may compare the image 22 (e.g., the facial pattern corresponding to the face 23 in the image 20) to the consumer profiles 32(1)-32(n) (hereinafter referred to individually as “a consumer profile 32”) in the consumer profile database 24 to identify the consumer. If no matches are found after searching the consumer profile database 24, the face detection module 22 may be optionally configured to create a new consumer profile 32 based on the face 23 in the captured image 20.

The face detection module 22 may be configured to identify a face 23 by extracting landmarks or features from the image 20 of the subject's face 23. For example, the face detection module 22 may analyze the relative position, size, and/or shape of the eyes, nose, cheekbones, and jaw, for example, to form a facial pattern. The face detection module 22 may use the identified facial pattern to search the consumer profiles 32(1)-32(n) for other images with matching facial pattern to identify the consumer. The comparison may be based on template matching techniques applied to a set of salient facial features. Such known face recognition systems may be based on, but are not limited to, geometric techniques (which looks at distinguishing features) and/or photometric techniques (which is a statistical approach that distill an image into values and comparing the values with templates to eliminate variances).

While not an exhaustive list, the face detection module 22 may utilize Principal Component Analysis with Eigenface, Linear Discriminate Analysis, Elastic Bunch Graph Matching fisherface, the Hidden Markov model, and the neuronal motivated dynamic link matching.

According to one embodiment, a consumer may generate and register a consumer profile 32 with the advertisement selection system 12. Alternatively (or in addition), one or more of the consumer profiles 32(1)-32(n) may be generated and/or updated by the advertisement selection module 28 as discussed herein. Each consumer profile 32 includes a consumer identifier and consumer demographical data. The consumer identifier may include data configured to uniquely identify a consumer based on the face recognition techniques used by the face detection module 22 as described herein (such as, but not limited to, pattern recognition and the like). The consumer demographical data represents certain characteristics and/or preferences of the consumer. For example, consumer demographical data may include preferences for certain types of goods or services, gender, race, age or age classification, income, disabilities, mobility (in terms of travel time to work or number of vehicles available), educational attainment, home ownership or rental, employment status, and/or location. Consumer demographical data may also include preferences for certain types/categories of advertising techniques. Examples of types/categories of advertising techniques may include, but are not limited to, comedy, drama, reality-based advertising, etc.

The advertisement selection module 28 may be configured to compare the consumer characteristics 30 (and optionally any consumer demographical data, if an identity of the consumer is known) with the advertisement profiles 34(1)-34(n) (hereinafter referred to individually as “an advertisement profile 34”) stored in the advertisement database 26. As described in greater detail herein, the advertisement selection module 28 may use various statistical analysis techniques for selecting one or more advertisements based on the comparison between the consumer characteristics 30 and the advertisement profiles 34(1)-34(n). For example, the advertisement selection module 28 may utilize a weighted average statistical analysis (including, but not limited to, a weighted arithmetic mean, weighted geometric mean, and/or a weighted harmonic mean).

In some embodiments, the advertisement selection module 28 may update a consumer profile 32 based on the consumer characteristics 30 and a particular advertisement and/or advertisement profile 32 currently being viewed. For example, the advertisement selection module 28 may update a consumer profile 32 to reflect a consumer's reaction (e.g., favorable, unfavorable, etc.) as identified in the consumer characteristics 30 to a particular advertisement and the advertisement's corresponding advertisement profile 32.

The advertisement selection module 28 may also be configured to transmit all or a portion of the consumer profiles 32(1)-32(n) to the content provider 16. As used herein, the term “content provider” includes broadcasters, advertising agencies, production studios, and advertisers. The content provider 16 may then utilize this information to develop future advertisements based on a likely audience. For example, the advertisement selection module 28 may be configured to encrypt and packetize data corresponding to the consumer profiles 32(1)-32(n) for transmission across a network 36 to the content provider 16. It may be appreciated that the network 36 may include wired and/or wireless communications paths such as, but not limited to, the Internet, a satellite path, a fiber-optic path, a cable path, or any other suitable wired or wireless communications path or combination of such paths.

The advertisement profiles 34(1)-34(n) may be provided by the content provider 16 (for example, across the network 36), and may include an advertisement identifier/classifier and/or advertisement demographical parameters. The advertisement identifier/classifier may be used to identify and/or classify a particular good or service into one or more predefined categories. For example, an advertisement identifier/classifier may be used to classify a particular advertisement into a broad category such as, but not limited to, as a “food/beverage,” “home improvement,” “clothing,” “health/beauty,” or the like. The advertisement identifier/classifier may also/alternatively be used to classify a particular advertisement into a narrower category such as, but not limited to, “beer advertisement,” “jewelry advertisement,” “holiday advertisement,” “woman's clothing advertisement,” or the like. The advertisement demographical parameters may include various demographical parameters such as, but not limited to, gender, race, age or age characteristic, income, disabilities, mobility (in terms of travel time to work or number of vehicles available), educational attainment, home ownership or rental, employment status, and/or location. The content provider 16 may optionally weight and/or prioritize the advertisement demographical parameters. Advertisement demographical parameters may also include identifications related to certain types/categories of advertising techniques. Examples of types/categories of advertising techniques may include, but are not limited to, comedy, drama, reality-based advertising, and the like.

The media device 18 is configured to display an advertisement from the content provider 16 which has been selected by the advertisement selection system 12. The media device 18 may include any type of display including, but not limited to, a television, an electronic billboard, a digital signage, a personal computer (e.g., desktop, laptop, netbook, tablet, etc.), a mobile phone (e.g., a smart phone or the like), a music player, or the like.

The advertisement selection system 12 (or a part thereof) may be integrated into a set-top box (STB) including, but not limited to, a cable STB, a satellite STB, an IP-STB, terrestrial STB, integrated access device (IAD), digital video recorder (DVR), smart phone (e.g., but not limited to, iPhone®, Trio®, Blackberry®, Droid®, etc.), a personal computer (including, but not limited to, a desktop computer, laptop computer, netbook computer, tablet computer (e.g., but not limited to, iPad®, Galazy Tab ®, and the like), etc.

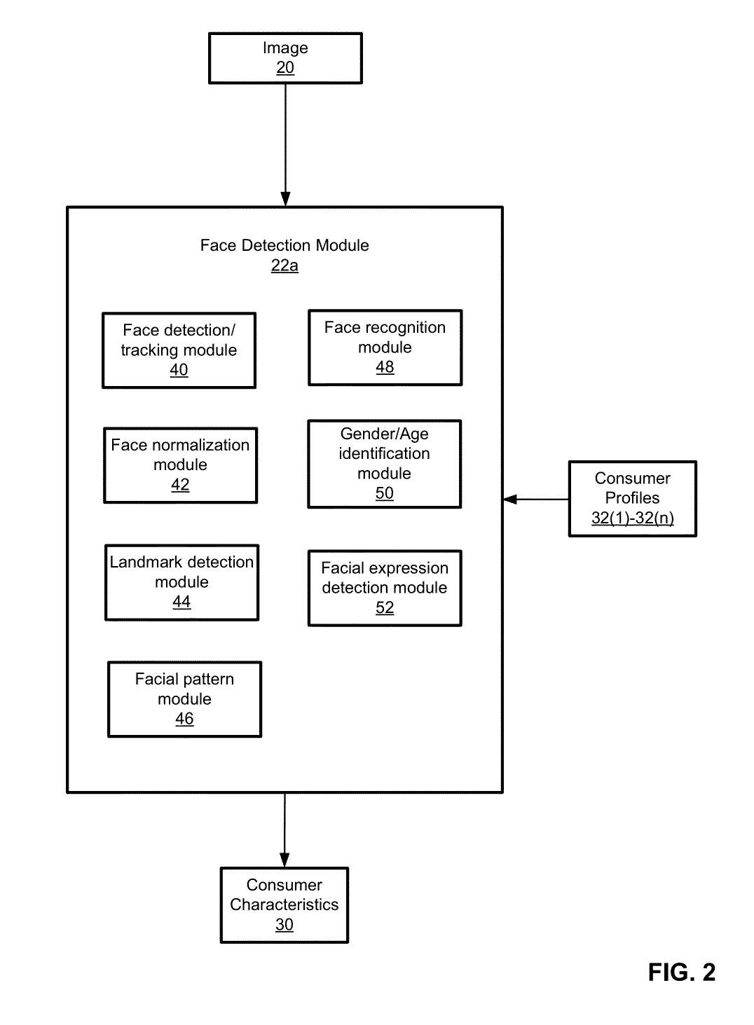

Turning now to FIG. 2, one embodiment of a face detection module 22a consistent with the present disclosure is generally illustrated. The face detection module 22a may be configured to receive an image 20 and identify, at least to a certain extent, a face (or optionally multiple faces) in the image 20. The face detection module 22a may also be configured to identify, at least to a certain extent, one or more facial characteristics in the image 20 and determine one or more consumer characteristics 30. The consumer characteristics 30 may be generated based on one or more of the facial parameters identified by the face detection module 22a as discussed herein. The consumer characteristics 30 may include, but are not limited to, a consumer identity (e.g., an identifier associated with a consumer) and/or facial characteristics (e.g., but not limited to, consumer age, consumer age classification (e.g., child or adult), consumer gender, consumer race,), and/or consumer expression identification (e.g., happy, sad, smiling, frown, surprised, excited, etc.)).

For example, one embodiment of the face detection module 22a may include a face detection/tracking module 40, a landmark detection module 44, a face normalization module 42, and a facial pattern module 46. The face detection/tracking module 40 may include custom, proprietary, known and/or after-developed face tracking code (or instruction sets) that is generally well-defined and operable to detect and identify, at least to a certain extent, the size and location of human faces in a still image or video stream received from the camera. Such known face detection/tracking systems include, for example, the techniques of Viola and Jones, published as Paul Viola and Michael Jones, Rapid Object Detection using a Boosted Cascade of Simple Features, Accepted Conference on Computer Vision and Pattern Recognition, 2001. These techniques use a cascade of Adaptive Boosting (AdaBoost) classifiers to detect a face by scanning a window exhaustively over an image. The face detection/tracking module 40 may also track an identified face or facial region across multiple images 20.

The face normalization module 42 may include custom, proprietary, known and/or after-developed face normalization code (or instruction sets) that is generally well-defined and operable to normalize the identified face in the image 20. For example, the face normalization module 42 may be configured to rotate the image to align the eyes (if the coordinates of the eyes are known), crop the image to a smaller size generally corresponding the size of the face, scale the image to make the distance between the eyes constant, apply a mask that zeros out pixels not in an oval that contains a typical face, histogram equalize the image to smooth the distribution of gray values for the non-masked pixels, and/or normalize the image so the non-masked pixels have mean zero and standard deviation one.

The landmark detection module 44 may include custom, proprietary, known and/or after-developed landmark detection code (or instruction sets) that is generally well-defined and operable to detect and identify, at least to a certain extent, the various facial features of the faces in the image 20. Implicit in landmark detection is that the face has already been detected, at least to some extent. Optionally, some degree of localization (for example, a course localization) may have been performed (for example, by the face normalization module 42) to identify/focus on the zones/areas of the image 20 where landmarks can potentially be found. For example, the landmark detection module 44 may be based on heuristic analysis and may be configured to identify and/or analyze the relative position, size, and/or shape of the eyes (and/or the corner of the eyes), nose (e.g., the tip of the nose), chin (e.g. tip of the chin), cheekbones, and jaw. Such known landmark detection systems include a six-facial points (i.e., the eye-corners from left/right eyes, and mouth corners) and six facial points (i.e., green points). The eye-corners and mouth corners may also be detected using Viola-Jones based classifier. Geometry constraints may be incorporated to the six facial points to reflect their geometry relationship.

The facial pattern module 46 may include custom, proprietary, known and/or after-developed facial pattern code (or instruction sets) that is generally well-defined and operable to identify and/or generate a facial pattern based on the identified facial landmarks in the image 20. As may be appreciated, the facial pattern module 46 may be considered a portion of the face detection/tracking module 40.

The face detection module 22a may optionally include one or more of a face recognition module 48, gender/age identification module 50, and/or a facial expression detection module 52. In particular, the face recognition module 48 may include custom, proprietary, known and/or after-developed facial identification code (or instruction sets) that is generally well-defined and operable to match a facial pattern with a corresponding facial pattern stored in a database. For example, the face recognition module 48 may be configured to compare the facial pattern identified by the facial pattern module 46, and compare the identified facial pattern with the facial patterns associated with the consumer profiles 32(1)-32(n) in the consumer profile database 24 to determine an identity of the consumer in the image 20. The face recognition module 48 may compare the patterns utilizing a geometric analysis (which looks at distinguishing features) and/or a photometric analysis (which is a statistical approach that distill an image into values and comparing the values with templates to eliminate variances). Some face recognition techniques include, but are not limited to, Principal Component Analysis with eigenface (and derivatives thereof), Linear Discriminate Analysis (and derivatives thereof), Elastic Bunch Graph Matching fisherface (and derivatives thereof), the Hidden Markov model (and derivatives thereof), and the neuronal motivated dynamic link matching.

Optionally, the face recognition module 48 may be configured to cause a new consumer profile 32 to be created in the consumer profile database 24 if a match with an existing consumer profile 32 is not found. For example, the face recognition module 48 may be configured to transfer data representing the identified consumer characteristics 30 to the consumer profile database 24. An identifier may then be created which is associated with a new consumer profile 32.

The gender/age identification module 50 may include custom, proprietary, known and/or after-developed gender and/or age identification code (or instruction sets) that is generally well-defined and operable to detect and identify the gender of the person in the image 20 and/or detect and identify, at least to a certain extent, the age of the person in the image 20. For example, the gender/age identification module 50 may be configured to analyze the facial pattern generated from the image 20 to identify which gender the person is in the image 20. The identified facial pattern may be compared to a gender database which includes correlation between various facial patterns and gender.

The gender/age identification module 50 may also be configured to determine and/or approximate a person's age and/or age classification in the image 20. For example, the gender/age identification module 50 may be configured to compare the identified facial pattern to an age database which includes correlation between various facial patterns and age. The age database may be configured approximate an actual age of the person and/or classify the person into one or more age groups. Examples of age groups may include, but are not limited to, adult, child, teenager, elderly/senior, etc.

The facial expression detection module 52 may include custom, proprietary, known and/or after-developed facial expression detection and/or identification code (or instruction sets) that is generally well-defined and operable to detect and/or identify facial expressions of the person in the image 20. For example, the facial expression detection module 52 may determine size and/or position of the facial features (e.g., eyes, mouth, cheeks, teeth, etc.) and compare the facial features to a facial feature database which includes a plurality of sample facial features with corresponding facial feature classifications (e.g., smiling, frown, excited, sad, etc.).

The face detection module 22a may generate consumer characteristics 30 based on or more of the parameters identified from the image 20. For example, the consumer characteristics 30 may include, but are not limited to, a consumer identity (e.g., an identifier associated with a consumer) and/or facial characteristics (e.g., but not limited to, consumer age, consumer age classification (e.g., child or adult), consumer gender, consumer race,), and/or consumer expressions (e.g., happy, sad, smiling, frown, surprised, excited, etc.)). The consumer characteristics 30 are used by the advertisement selection module 28 to identify and/or select one or more advertisements to present to the consumer as discussed herein.

In one example embodiment, one or more aspects of the face detection module 22a (e.g., but not limited to, face detection/tracking module 40, recognition module 48, gender/age module 50, and/or facial expression detection module 52) may use a multilayer perceptron (MLP) model that iteratively maps one or more inputs onto one or more outputs. The general framework for the MLP model is known and well-defined, and generally includes a feedforward neural network that improves on a standard linear preceptron model by distinguishing data that is not linearly separable. In this example, the inputs to the MLP model may include one or more shape features generated by the landmark detection module 44. The MLP model may include an input layer defined by a plurality of N number of input nodes. Each node may comprise a shape feature of the face image. The MLP model may also include a “hidden” or iterative layer defined by a plurality of N number of “hidden” neurons. Typically, M is less than N, and each node of the input layer is connected to each neuron in the “hidden” layer.

The MLP model may also includes an output layer defined by a plurality of output neurons. Each output neuron may be connected to each neuron in the “hidden” layer. An output neuron, generally, represents a probability of a predefined output. The number of outputs may be predefined and, in the context of this disclosure, may match the number of faces and/or face gestures that may be identified by the face detection/tracking module 40, face recognition module 48, gender/age module 50, and/or facial expression detection module 52. Thus, for example, each output neuron may indicate the probability of a match of the face and/or face gesture images, and the last output is indicative of the greatest probability.

In each layer of the MLP model, given the inputs xⱼ of a layer m, the outputs Lᵢ of the layer n+1 are computed as:

$$\begin{matrix}{u}_{i} = {\sum }_{j} ( {w}_{i , j}^{n + 1} \cdot {x}_{j} ) + {w}_{i , bias}^{n + 1} & EQ . 1 \\ {y}_{i} = f ( {u}_{i} ) & EQ . 2\end{matrix}$$

The f function, assuming a sigmoid activation function, may be defined as:

ƒ(x)=β·(1−e^{-αx})/(1+e^{-αx}) EQ. 3

The MLP model may be enabled to learn using backpropogation techniques, which may be used to generate the parameters α, β are learned from the training procedure. Each input xⱼ may be weighted, or biased, indicating a stronger indication of face and/or face gesture type. The MLP model may also include a training process which may include, for example, identifying known faces and/or face gestures so that the MLP model can “target” these known faces and/or face gestures during each iteration.

The output(s) of the face detection/tracking module 40, face recognition module 48, gender/age module 50, and/or facial expression detection module 52 may include a signal or data set indicative of the type of face and/or face gesture identified. This, in turn may be used to generate the consumer characteristic data/signal 30, which may be used to select one or more advertisement profiles 32(1)-32(n) as discussed herein.

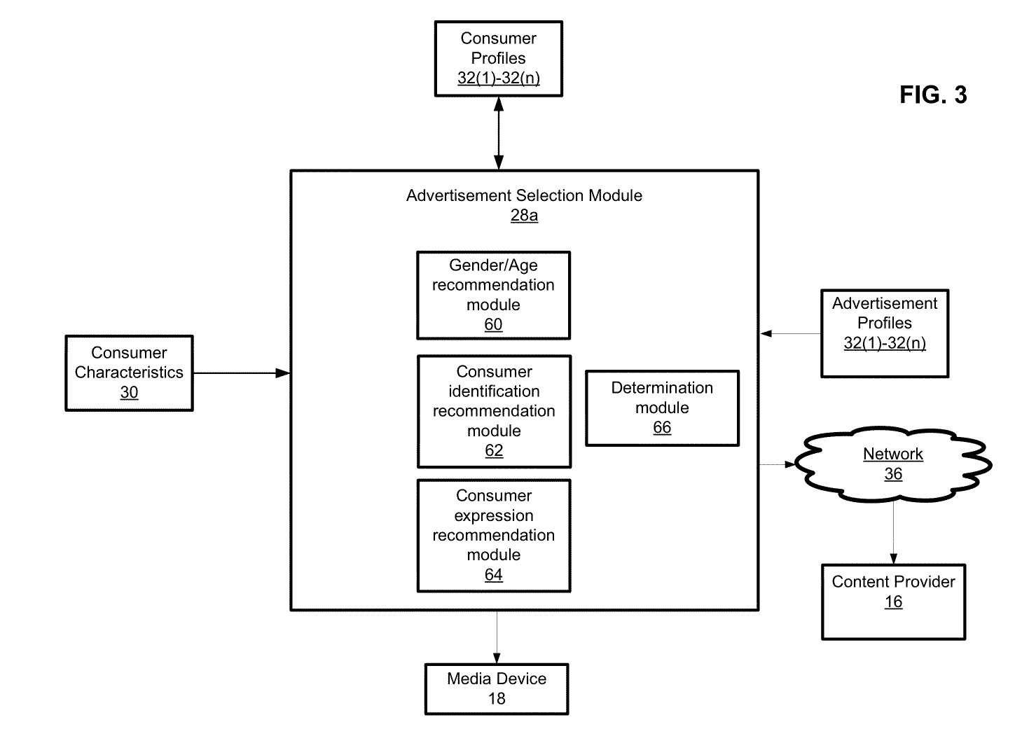

Turning now to FIG. 3, one embodiment of an advertisement selection module 28a consistent with the present disclosure is generally illustrated. The advertisement selection module 28a is configured to select at least one advertisement from the advertisement database 26 based, at least in part, on a comparison of the consumer characteristic data 30 identified by the face detection module 22 and the advertisement profiles 34(1)-34(n) in the advertisement database 26. Optionally, the advertisement selection module 28a may use the characteristic data 30 to identify a consumer profile 32 from the consumer profile database 24. The consumer profile 32 may also include parameters used by the advertisement selection module 28a in the selection of an advertisement as described herein. The advertisement selection module 28a may update and/or create a consumer profile 32 in the consumer profile database 24 and associate the consumer profile 32 with the characteristic data 30.

According to one embodiment, the advertisement selection module 28a includes one or more recommendation modules (for example, a gender and/or age recommendation module 60, a consumer identification recommendation module 62, and/or a consumer expression recommendation module 64) and a determination module 66. As discussed herein, the determination module 66 is configured to select one or more advertisements based on a collective analysis of the recommendation modules 60, 62, and 64.

The gender and/or age recommendation module 60 may be configured to identity and/or rank one or more advertisements from the advertisement database 26 based on, at least in part, a comparison of advertisement profiles 32(1)-32(n) with the consumer's age (or approximation thereof), age classification/grouping (e.g., adult, child, teenager, senior, or like) and/or gender (hereinafter collectively referred to as “age/gender data”). For example, the gender and/or age recommendation module 60 may identify consumer age/gender data from the characteristic data 30 and/or from an identified consumer profile 32 as discussed herein. The advertisement profiles 32(1)-32(n) may also include data representing a classification, ranking, and/or weighting of the relevancy of each of the advertisements with respect to one or more types of age/gender data (i.e., a target audience) as supplied by the content provider and/or the advertising agency. The gender and/or age recommendation module 60 may then compare the consumer age/gender data with the advertising profiles 32(1)-32(n) to identify and/or rank one or more advertisements.

The consumer identification recommendation module 62 may be configured to identity and/or rank one or more advertisements from the advertisement database 26 based on, at least in part, a comparison of advertisement profiles 32(1)-32(n) with an identified consumer profile. For example, the consumer identification recommendation module 62 may identify consumer preferences and/or habits based on previous viewing history and reactions thereto associated with the identified consumer profile 32 as discussed herein. Consumer preferences/habits may include, but are not limited to, how long a consumer watches a particular advertisement (i.e., program watching time), what types of advertisements the consumer watches, the day, day of the week, month, and/or time that a consumer watches an advertisement, and/or the consumer's facial expressions (smile, frown, excited, gaze, etc.), and the like. The consumer identification recommendation module 62 may also store identified consumer preferences/habits with an identified consumer profile 32 for later use. The consumer identification recommendation module 62 may therefore compare a consumer history associated with a particular consumer profile 32 to determine which advertisement profiles 32(1)-32(n) to recommend.

To identify which advertisements to recommend, the consumer identification recommendation module 62 the identity of the consumer may be matched with a particular, existing consumer profile 32. The identification, however, does not necessarily require that the content selection module 28a knows consumer's name or username, but rather may be anonymous in the sense that the content selection module 28a merely needs to be able to recognize/associate the consumer in the image 20 to an associated consumer profile 32 in the consumer profile database 24. Therefore, while a consumer may register himself with an associated consumer profile 32, this is not a requirement.

The consumer expression recommendation module 64 is configured to compare the consumer expressions in the consumer characteristic data 30 to the advertisement profile 32 associated with the advertisement that the consumer is currently viewing. For example, if the consumer characteristic data 30 indicates that the consumer is smiling or gazing (e.g., as determined by the facial expression detection module 52), the consumer expression recommendation module 64 may infer that the advertisement profile 32 of the advertisement that the consumer is watching is favorable. The consumer expression recommendation module 64 may therefore identify one or more additional advertisement profiles 32(1)-32(n) which are similar to the advertisement profile 32 of the advertisement being watched. Additionally, the consumer expression recommendation module 64 may also update an identified consumer profile 32 (assuming a consumer profile 32 has been identified).

The determination module 66 may be configured to weigh and/or rank the recommendations from the various recommendation modules 60, 62, and 64. For example, the determination module 66 may select one or more advertisements based on a heuristic analysis, a best-fit type analysis, regression analysis, statistical inference, statistical induction, and/or inferential statistics on the advertisement profiles 34 recommended by the recommendation modules 60, 62, and 64 to identify and/or rank one or more advertisement profiles 32 to present to the consumer. It should be appreciated that the determination module 66 does not necessarily have to consider all of the consumer data. In addition, the determination module 66 may compare the recommended advertisement profiles 32 identified for a plurality of consumers simultaneously watching. For example, the determination module 66 may utilize different analysis techniques based on the number, age, gender, etc. of the plurality of consumers watching. For example, the determination module 66 may reduce and/or ignore one or more parameters and/or increase the relevancy of one or more parameters based on the characteristics of the group of consumers watching. By way of example, the determination module 66 may default to presenting advertisements for children if a child is identified, even if there are adults present. By way of further example, the determination module 66 may present advertisements for women if more women are detected than men. Of course, these examples are not exhaustive, and the determination module 66 may utilize other selection techniques and/or criterion.

Optionally, the content selection module 28a may be configured to transmit the collected consumer profile data (or a portion thereof) to the content provider 16. The content provider 16 may then resell this information and/or use the information to develop future advertisements based on a likely audience.

According to one embodiment, the content selection module 28a may transmit a signal to the content provider 16 representing one or more selected advertisements to present to the consumer. The content provider 16 may then transmit a signal to the media device 18 with the corresponding advertisement. Alternatively, the advertisements may be stored locally (e.g., in a memory associated with the media device 18 and/or the advertisement selection system 12) and the content selection module 28a may be configured to cause the selected advertisement to be presented on the media device 18.

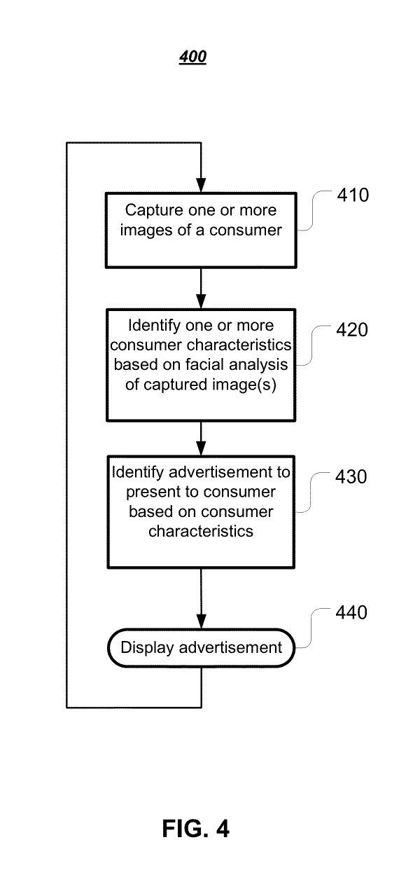

Turning now to FIG. 4, a flowchart illustrating one embodiment of a method 400 for selecting and displaying an advertisement is illustrated. The method 400 includes capturing one or more images of a consumer (operation 410). The images may be captured using one or more cameras. A face and/or face region may be identified within the captured image and at least one consumer characteristics may be determined (operation 420). In particular, the image may be analyzed to determine one or more of the following consumer characteristics: the consumer's age, the consumer's age classification (e.g., child or adult), the consumer's gender, the consumer's race, the consumer's emotion identification (e.g., happy, sad, smiling, frown, surprised, excited, etc.), and/or the consumer's identity (e.g., an identifier associated with a consumer). For example, the method 400 may include comparing one or more face landmark patterns identified in the image to a set of consumer profiles stored in a consumer profile database to identify a particular consumer. If no match is found, the method 400 may optionally include creating a new consumer profile in the consumer profile database.

The method 400 also includes identifying one or more advertisements to present to the consumer based on the consumer characteristics (operation 430). For example, the method 400 may compare the consumer characteristics to a set of advertisement profiles stored in an advertisement database to identify a particular advertisement to present to a consumer. Alternatively (or in addition), the method 400 may compare a consumer profile (and a corresponding set of consumer demographical data) to the advertisement profiles to identify a particular advertisement to present to a consumer. For example, the method 200 may use the consumer characteristics to identify a particular consumer profile stored in the consumer profile database.

The method 400 further includes displaying the selected advertisement to the consumer (operation 440). The method 400 may then repeat itself. Optionally, the method 400 may update a consumer profile in the consumer profile database based on the consumer characteristics related to a particular advertisement being viewed. This information may be incorporated into the consumer profile stored in the consumer profile database and used for identifying future advertisements.

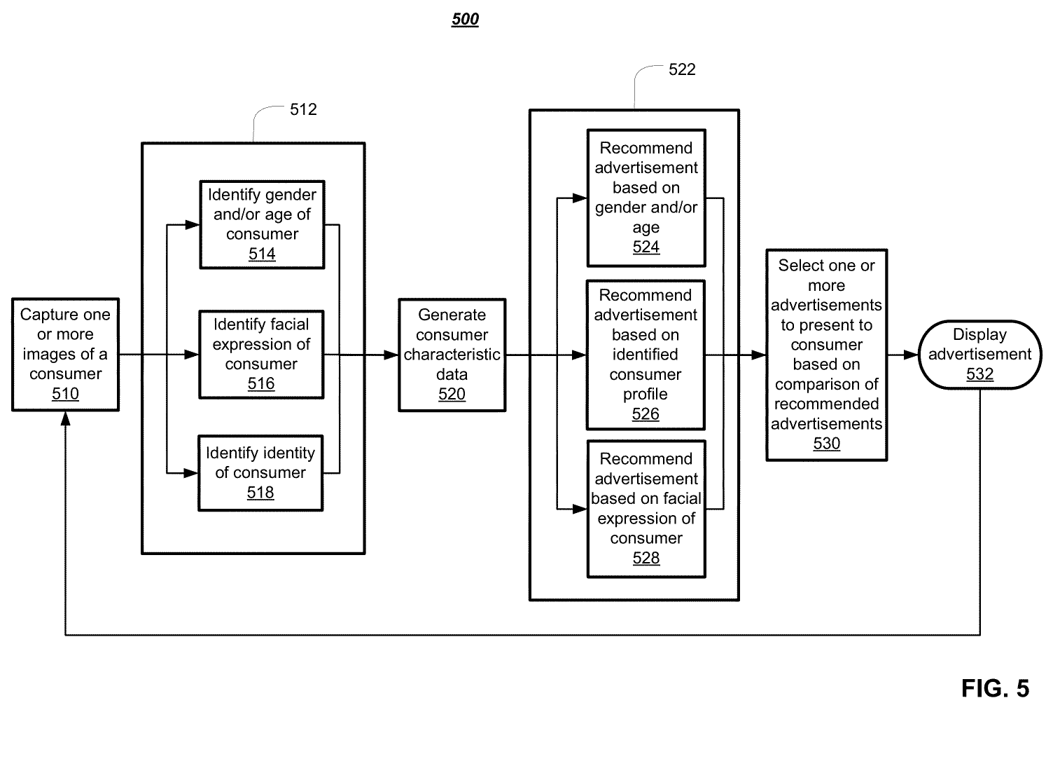

Referring now to FIG. 5, illustrates another flowchart of operations 500 for selecting and displaying an advertisement based on a captured image of a consumer in a viewing environment. Operations according to this embodiment include capturing one or more images using one or more cameras (operation 510). Once the image has been captured, facial analysis is performed on the image (operation 512). Facial analysis 512 includes identifying the existence (or not) of a face or facial region in the captured image, and if a face/facial region is detected, then determining one or more characteristics related to the image. For example, the gender and/or age (or age classification) of the consumer may be identified (operation 514), the facial expressions of the consumer may be identified (operation 516), and/or identity of the consumer may be identified (operation 518). Once facial analysis has been performed, consumer characteristic data may be generated based on the facial analysis (operation 520). The consumer characteristic data is then compared with a plurality of advertisement profiles associated with a plurality of different advertisements to recommend one or more advertisements (operation 522). For example, the consumer characteristic data may be compared with the advertisement profiles to recommend one or more advertisements based on the gender and/or age of the consumer (operation 524). The consumer characteristic data may be compared with the advertisement profiles to recommend one or more advertisements based on the identified consumer profile (operation 526). The consumer characteristic data may be compared with the advertisement profiles to recommend one or more advertisements based on the identified facial expressions (operation 528). The method 500 also includes selecting one or more advertisements to present to the consumer based on a comparison of the recommended advertisement profiles (operation 530). The selection of the advertisement(s) may be based on a weighing and/or ranking of the various selection criteria 524, 526, and 528. A selected advertisement is then displayed to the consumer (operation 532).

The method 500 may then repeat starting at operation 510. The operations for selecting an advertisement based on a captured image may be performed substantially continuously. Alternatively, one or more of the operations for selecting an advertisement based on a captured image (e.g., facial analysis 512) may be periodically run periodically and/or at an interval of a small amount of frames (e.g., 30 frames). This may be particularly suited for applications in which the advertisement selection system 12 is integrated into platforms with reduced computational capacities (e.g., less capacity than personal computers).

While FIGS. 4 and 5 illustrate method operations according various embodiments, it is to be understood that in any embodiment not all of these operations are necessary. Indeed, it is fully contemplated herein that in other embodiments of the present disclosure, the operations depicted in FIGS. 4 and 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

As used in any embodiment herein, the term “module” refers to software, firmware and/or circuitry configured to perform the stated operations. The software may be embodied as a software package, code and/or instruction set or instructions, and “circuitry”, as used in any embodiment herein, may comprise, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), etc.

Certain embodiments described herein may be provided as a tangible machine-readable medium storing computer-executable instructions that, if executed by the computer, cause the computer to perform the methods and/or operations described herein. The tangible computer-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The computer may include any suitable processing platform, device or system, computing platform, device or system and may be implemented using any suitable combination of hardware and/or software. The instructions may include any suitable type of code and may be implemented using any suitable programming language.

Thus, in one embodiment the present disclosure provides a method for selecting an advertisement to present to a consumer. The method includes detecting, by a face detection module, a facial region in an image; identifying, by the face detection module, one or more consumer characteristics of the consumer in the image; identifying, by an advertisement selection module, one or more advertisements to present to the consumer based on a comparison of the consumer characteristics with an advertisement database including a plurality of advertisement profiles; and presenting, on a media device, a selected one of the identified advertisement to the consumer.

In another embodiment, the present disclosure provides an apparatus for selecting an advertisement to present to a consumer. The apparatus includes a face detection module configured to detecting a facial region in an image and identify one or more consumer characteristics of the consumer in the image, an advertisement database including a plurality of advertisement profiles, and an advertisement selection module configured to select one or more advertisements to present to the consumer based on a comparison of the consumer characteristics with the plurality of advertisement profiles.

In yet another embodiment, the present disclosure provides tangible computer-readable medium including instructions stored thereon which, when executed by one or more processors, cause the computer system to perform operations comprising detecting a facial region in an image; identifying one or more consumer characteristics of said consumer in said image; and identifying one or more advertisements to present to said consumer based on a comparison of said consumer characteristics with an advertisement database including a plurality of advertisement profiles.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

What is claimed is:

1-19. (canceled)

20. One or more non-transitory computer readable memories of a set-top box and a handheld device which collectively store instructions that, when executed by said at least one processor of said set-top box and said handheld device, result in the following operations comprising:
generating an image of a consumer using a camera of said handheld device;
detecting a face in said image;
identifying a facial pattern and a facial expression of said consumer in said image, wherein said facial pattern is determined based, at least in part, on at least one of a facial landmark or a facial feature extracted from said image and wherein said facial expression is identified as being at least one of favorable or unfavorable;
identifying at least one of a plurality of consumer profiles stored in a consumer profile database based, at least in part, on said facial pattern and facial data within said plurality of consumer profiles;
identifying one or more advertisements to present to said consumer based on a comparison of said identified consumer profile with a plurality of advertisement profiles, said advertisement profiles being associated with a plurality of advertisements; and
generating a signal to cause a display to present said identified one or more advertisements.

21. The one or more non-transitory computer readable memories of claim 20, wherein said one or more non-transitory computer readable memories of said set-top box store said instructions that, when executed by said at least one processor of said set-top box, result in:
said identifying at least one of said plurality of consumer profiles stored in a consumer profile database; and
said identifying one or more advertisements to present to said consumer.

22. The one or more non-transitory computer readable memories of claim 21, wherein said one or more non-transitory computer readable memories of said handheld device store said instructions that, when executed by said at least one processor of said handheld device, result in:
said detecting said face in said image.

23. The one or more non-transitory computer readable memories of claim 22, wherein said one or more non-transitory computer readable memories of said handheld device store said instructions that, when executed by said at least one processor of said handheld device, result in:
said identifying said facial pattern and said facial expression of said consumer in said image.

24. The one or more non-transitory computer readable memories of claim 22, wherein said one or more non-transitory computer readable memories of said set-top box store said instructions that, when executed by said at least one processor of said set-top box, result in:
said identifying said facial pattern and said facial expression of said consumer in said image.

25. The one or more non-transitory computer readable memories of claim 20, wherein said one or more non-transitory computer readable memories of said handheld device store said instructions that, when executed by said at least one processor of said handheld device, result in:
said identifying said facial pattern and said facial expression of said consumer in said image;
said identifying at least one of said plurality of consumer profiles stored in said consumer profile database; and
said identifying one or more advertisements to present to said consumer.

26. The one or more non-transitory computer readable memories of claim 25, wherein said one or more non-transitory computer readable memories of said set-top box store said instructions that, when executed by said at least one processor of said set-top box, result in:
said identifying at least one of said plurality of consumer profiles stored in said consumer profile database; and
said identifying one or more advertisements to present to said consumer.

27. The one or more non-transitory computer readable memories of claim 25, wherein said one or more non-transitory computer readable memories of said handheld device store said instructions that, when executed by said at least one processor of said handheld device, result in:
said identifying at least one of said plurality of consumer profiles stored in said consumer profile database; and
said identifying one or more advertisements to present to said consumer.

28. The one or more non-transitory computer readable memories of claim 27, wherein said one or more non-transitory computer readable memories of said set-top box store said instructions that, when executed by said at least one processor of said set-top box, result in:
said generating said signal.

29. The one or more non-transitory computer readable memories of claim 20, wherein said handheld device comprises a smartphone.

30. The one or more non-transitory computer readable memories of claim 20, wherein said operations further comprise updating said identified consumer profile based, at least in part, on said identified facial expression and an advertisement profile associated with an advertisement currently being viewed.

31. The one or more non-transitory computer readable memories of claim 30, wherein said operations further comprise, in response to updating said consumer profile, identifying an additional advertisement to present to said consumer based, at least in part on, a comparison of said updated consumer profile with said plurality of advertisement profiles.

32. The one or more non-transitory computer readable memories of claim 20, wherein each consumer profile further comprises consumer provided demographic data, said consumer provided demographic data including at least one of an age, an age classification, or a gender of said consumer.

33. The one or more non-transitory computer readable memories of claim 32, wherein said operations further comprise:
detecting an additional face in said image;
identifying an additional consumer profile associated with an additional consumer; and
selecting a recommended consumer profile from said identified consumer profiles, said selection based upon a comparison of said consumer provided demographic data associated with each of said identified consumer profiles;
wherein said identifying of one or more advertisements to present to said consumer is based, at least in part, on a comparison of said recommended consumer profile with said plurality of advertisement profiles.

34. The one or more non-transitory computer readable memories of claim 32, wherein said identifying said one or more advertisements to present to said consumer further comprises comparing said consumer provided demographic data with at least one of an advertisement demographical parameter or an advertisement identifier.

35. The one or more non-transitory computer readable memories of claim 20, wherein said identifying one or more advertisements to present to said consumer comprises a comparison of at least one of a classification, ranking, or weighting of advertisement attributes of each of the respective advertisement profiles with one or more corresponding attributes of the identified consumer profile.

36. The one or more non-transitory computer readable memories of claim 20, wherein said operations further comprise transmitting at least a portion of said identified consumer profile to a content provider.

37. The one or more non-transitory computer readable memories of claim 20, wherein said operations further comprise: detecting an additional face in said image;
identifying an additional consumer profile associated with an additional consumer; and
adjusting a relevancy of one or more consumer profile attributes associated with said identified consumer profiles based, at least in part, on a comparison of said identified consumer profiles;
wherein said identifying one or more advertisements to present to said consumer is based, at least in part, on said adjusted relevancy of said consumer profile attributes.

38. The one or more non-transitory computer readable memories of claim 37, wherein said adjusting said relevancy of one or more consumer profile attributes comprising reducing or increasing said relevancy of one or more consumer profile attributes.

39. The one or more non-transitory computer readable memories of claim 20, wherein said generating said signal to cause said display to present said identified one or more advertisements comprises transmitting a signal to a content provider to cause said content provider to provide said identified one or more advertisements to said set-top box.

40. The one or more non-transitory computer readable memories of claim 20, wherein said generating said signal to cause said display to present said identified one or more advertisements comprises transmitting said signal to said display, said signal comprising said identified one or more advertisements stored in said set-top box.

41. A method implemented by combination of a set-top box and a handheld device comprising:
generating an image of a consumer using a camera of said handheld device;
detecting a face in said image;
identifying a facial pattern and a facial expression of said consumer in said image, wherein said facial pattern is determined based, at least in part, on at least one of a facial landmark or a facial feature extracted from said image;
identifying at least one of a plurality of consumer profiles stored in a consumer profile database based, at least in part, on said facial pattern and facial data within said plurality of consumer profiles;
identifying one or more advertisements to present to said consumer based on a comparison of said identified consumer profile with a plurality of advertisement profiles, said advertisement profiles being associated with a plurality of advertisements; and
generating a signal to cause a display to present said identified one or more advertisements.

42. The method of claim 41, wherein said set-top box performs:
said identifying at least one of said plurality of consumer profiles stored in a consumer profile database; and
said identifying one or more advertisements to present to said consumer.

43. The method of claim 42, wherein said handheld device performs:
said detecting said face in said image.

44. The method of claim 43, wherein said handheld device performs:
said identifying said facial pattern and said facial expression of said consumer in said image.

45. The method of claim 43, wherein said set-top box performs:
said identifying said facial pattern and said facial expression of said consumer in said image.

46. The method of claim 41, wherein said handheld device performs:
said identifying said facial pattern and said facial expression of said consumer in said image;
said identifying at least one of said plurality of consumer profiles stored in said consumer profile database; and
said identifying one or more advertisements to present to said consumer.

47. The method of claim 46, wherein said set-top box performs:
said identifying at least one of said plurality of consumer profiles stored in said consumer profile database; and
said identifying one or more advertisements to present to said consumer.

48. The method of claim 46, wherein said handheld device performs:
said identifying at least one of said plurality of consumer profiles stored in said consumer profile database; and
said identifying one or more advertisements to present to said consumer.

49. The method of claim 48, wherein said set-top box performs:
said generating said signal.

50. A system for selecting an advertisement to present to a consumer on a display, said system comprising:
a handheld device comprising a camera for generating an image of said consumer; and
a set-top box to receive said image from said handheld device, said set-top box further comprising:
at least one processor;
a consumer profile database stored, individually or in combination, on one or more non-transitory computer readable memories of said set-top box, said consumer profile database to include a plurality of consumer profiles, wherein each consumer profile includes facial data;
an advertisement database stored, individually or in combination, on said one or more non-transitory computer readable memories of said set-top box, said advertisement database including a plurality of advertisement profiles associated with a plurality of advertisements; and
a plurality of instructions, stored individually or in combination, on one or more non-transitory computer readable memories of said set-top box which when executed by said at least one processor, result in said set-top box carrying out operations comprising:
detecting a face in said received image;
identifying a facial pattern and a facial expression of said consumer in said received image, wherein said facial pattern is determined based, at least in part, on at least one of a facial landmark or a facial feature extracted from said image and wherein said facial expression is identified as being at least one of favorable or unfavorable;
identifying at least one consumer profile stored in said consumer profile database based, at least in part, on said facial pattern and said facial data within said plurality of consumer profiles;
identifying one or more advertisements to present to said consumer based on a comparison of said identified consumer profile with a plurality of advertisement profiles; and
generating a signal to cause said display to present said identified one or more advertisements.

51. The system of claim 50, wherein said handheld device comprises at least one of a smartphone or a tablet.

52. A smartphone comprising
a camera;
at least one processor; and
one or more non-transitory computer readable memories which store, individually or in combination, instructions that, when executed by said at least one processor, result in said handheld device carrying out operations comprising:
generating an image of a consumer using said camera;
detecting a face in said image;
identifying a facial pattern and a facial expression of said consumer in said image, wherein said facial pattern is determined based, at least in part, on at least one of a facial landmark or a facial feature extracted from said image;
identifying at least one of a plurality of consumer profiles stored in a consumer profile database based, at least in part, on said facial pattern and facial data within said plurality of consumer profiles and wherein said facial expression is identified as being at least one of favorable or unfavorable;
identifying one or more advertisements to present to said consumer based on a comparison of said identified consumer profile with a plurality of advertisement profiles, said advertisement profiles being associated with a plurality of advertisements; and
generating a signal to cause a display to present said identified one or more advertisements.
